(19) United States
(12) Patent Application Publication
(10) Pub. No.: US 2022/0388408 A1
(43) Pub. Date: Dec. 8, 2022

(54) Vehicle unit comprising a charging connection, and charging system for charging a battery of an electric vehicle

(71) Applicant: Webasto SE, Stockdorf (DE)

(72) Inventor: Thomas Podolski, Stockdorf (DE)

(21) Appl. No.: 17/776,195

(22) PCT Filed: Nov. 12, 2020
(86) PCT No.: PCT/EP2020/081953

§ 371 Date: May 11, 2022

(30) Foreign Application Priority Data
Nov. 12, 2019 (DE) 10 2019 130 551.9

(51) Int. Cl. B60L 53/16; B60L 53/35

(52) U.S. Cl. CPC B60L 53/16; B60L 53/35

(57) ABSTRACT

A vehicle unit for installing in an electric vehicle, preferably in a floorpan of the electric vehicle, and for electrically contacting an external charging device for charging a battery of the electric vehicle, said vehicle unit having: a charging connection for contacting a contacting apparatus of the external charging device in a contact position; and a contacting mechanism designed to transfer the contacting apparatus along a trajectory on an X/Y-plane, from a centering position, in which the contacting apparatus is separated from the charging connection, into the contact position.

### CROSS-REFERENCE TO RELATED APPLICATIONS

This application is a 35 U.S.C. § 371 National Stage Entry of International Application No. PCT/EP2020/081953 filed Nov. 12, 2020, which claims the priority benefit of German Patent Application Serial Number DE 10 2019 130 551.9 filed Nov. 12, 2019, all of which are incorporated herein by reference in their entirety for all purposes.

### TECHNICAL FIELD

The present invention relates to a vehicle unit and a charging system for charging a battery of an electric vehicle, in particular for charging a traction battery of a motor vehicle driven by an electric motor.

### BACKGROUND

Motor vehicles having an electric drive, for example electric and hybrid vehicles and vehicles with fuel cells, are the subject of current research and development with regard to many technical aspects. The energy required to drive the electric motor is stored in a traction battery.

For external charging of traction batteries in motor vehicles having an electric drive, contacting of the vehicle by a charging device, for example a charging station or a so-called wall box, is established in that the user guides a charging cable with a plug from the charging device to the vehicle and there inserts the plug into a suitable socket on the vehicle. The user then starts the charging procedure.

Various disadvantageous are associated with such a manual charging procedure. In this regard, the charging device with a charging cable requires space, which cannot be used for something else. The charging cable extends to the vehicle from a wall box, for example, which is installed on the wall of a garage, and may possibly block a passageway and therefore form a trip hazard. The manual connection of the charging cable to the vehicle and the operation of the charging device is furthermore inconvenient and prone to faults. It may be that the user forgets to connect the vehicle for charging or even to disconnect the charging cable before driving off.

Efforts have therefore been made to automate the contacting by the charging device for charging the vehicle. To this end, different concepts are being trialed, wherein wall-mounted automatic contacting devices have been proposed, for example, which insert a charging cable automatically/mechanically into a socket on the vehicle. This can be achieved for example via an extending arm.

Contacting devices are furthermore known, which are arranged on or in the floor of a parking spot. In this case, the vehicle is driven onto a parking spot equipped with such a charging device and brought to a standstill above the contacting device. Contacting of the vehicle then takes place automatically from below via a lifting device. The lifting device inserts a plug, from below, into a socket which is installed in the underfloor of the vehicle.

However, since it is generally not possible to ensure a precise parking position of the vehicle, automatic centering of the plug has to be realized by the charging device in the floor. The contacts of the vehicle unit arranged in the underfloor of the vehicle and the contacts of the charging device in the floor are further exposed to significant mechanical loads, such as road stones, contamination and spray water, which can easily lead to damage.

DE 10 218 205 594 A1 describes a motor vehicle having an electrical contacting unit. The contacting unit comprises electrical contacts and a displaceable cover, which can be displaced between a protective position, in which it covers the electrical contacts, and a charging position, in which the electrical contacts are accessible from the vehicle surroundings. The contacting takes place in a direction perpendicular to the underfloor of the vehicle.

The plug described as a “mating piece” in DE 10 2018 205 594 A1 is lifted to the contacting unit on the vehicle via a robot arm. The circular, concentric contacts of the plug are open towards the top and therefore exposed to significant contamination without further technical measures.

### Presentation of the Invention

Starting with the known prior art, an object of the present invention is to further improve the automatic contacting of an external charging device with a vehicle unit for charging an electric vehicle.

The object is solved by a vehicle unit having the features of claim 1 and a charging system having the features of claim 14. Advantageous developments follow in the subclaims, the following description of the invention and the description of preferred exemplary embodiments.

The term “electric vehicle” functions here as a generic term for vehicles having only an electric drive, in which the energy required for the driving operation is stored exclusively in a traction battery, and hybrid vehicles of all types, in which the driving energy is stored at least in part in an externally chargeable traction battery. Plug-in hybrid vehicles as well as vehicles with a fuel cell therefore come under the term “electric vehicle”, for example, provided the traction battery can also be charged externally in addition to charging via a fuel cell.

The vehicle unit according to the invention is provided for installation in an electric vehicle or is already installed in an electric vehicle. In this case, the vehicle unit can be realized as a modular structural unit or integrated in the electric vehicle. The vehicle unit is preferably installed in the underfloor of the electric vehicle or is installable, for example screwable, thereon or therein. The vehicle unit serves for electrical contacting of an external charging device, such as a charging station located in the floor, for charging a battery of the electric vehicle.

The vehicle unit has a charging connection for contacting, in particular for mechanical and electrical contacting, of a contacting device of the external charging device. The state in which the charging connection of the vehicle unit and the external contacting device are in contact, so that charging current can flow from the external charging device to the battery in order to charge this latter, is also referred to herein as “contact position”.

The charging connection and the contacting device are preferably in form-fitting and electrical communication in the contact state. In particular, the contacting device and the charging connection establish a plug/socket connection in order to ensure reliable contacting. In this case, the contacting device preferably functions as a plug, whilst the charging connection functions as a socket. However, the form fit can also be realized the other way around. A form fit between the contacting device and charging connection is furthermore not absolutely necessary if secure electrical contact is ensured in the contact position.

According to the invention, the vehicle unit further has a contacting mechanism, which is designed to transfer the contacting device along a trajectory in a plane, which shall be referred to herein as “XN plane”, from a centering position, in which the contacting device is not connected to the charging connection, to the contact position.

In other words, the starting point is a defined position of the contacting device in the XN plane, which is achieved for instance by means of an external device, for example by means of a robot arm. This defined position, in which the contacting device can already be incorporated in the vehicle unit or a recess thereof but is not yet in contact with the charging connection, is referred to herein as “centering position”. The centering position therefore refers to a well-defined, spatial position of the contacting device; however, in particular the alignment thereof, i.e. the angle about the axis perpendicular to the XN plane, which shall be referred to herein as “Z axis”, may be unspecified. The transfer of the contacting device into the contact state now no longer takes place by means of an external device, but is carried out by the contacting mechanism, which is a mechanism of the vehicle unit.

Particularly convenient charging of the battery of the electric vehicle can thus be realized, in which the driver, after parking the motor vehicle approximately above a floor unit of the external charging device and possibly as a result of initiating the charging procedure, does not have to undertake any further steps since the system can carry this out automatically and independently. In particular, for the contacting of the battery by the charging device, the user does not need to guide a charging cable with a plug from a wall box or a charging station to the motor vehicle and insert the plug manually into a charging socket on the vehicle; instead, this procedure takes place automatically.

Similarly, it can thus be effectively avoided that a user who is ready to drive off needs to climb out of the vehicle again to release the connection if the contacting of the motor vehicle is still established. Instead, by means of the proposed technical solution, automatic, independent disconnection can also be achieved, which is executed for example when the actual charging procedure has ended, i.e. the battery is sufficiently or completely recharged, or is initiated for example by opening the motor vehicle door, stepping inside the motor vehicle or starting the motor vehicle. In other words, a user does not have to undertake any active steps to disconnect the established contacting by the charging device. However, it can also be provided that the user specifies active disconnection via a corresponding disconnect command.

In this case, the alignment and transfer of the contacting device into the contact state takes place at least in part within and via active technical means of the vehicle unit, i.e. via technical means which are located on board the vehicle. This technical solution is less sensitive to tolerances, more robust and more reliable than contacting entirely via an external device, such as a robot arm. Moreover, the forces on the external device are reduced, thereby facilitating a lightweight construction of the charging system.

Contacts of the charging connection, which are to be brought into electrical contact with contacts of the contacting device for charging purposes, are preferably aligned parallel to the X/Y plane, wherein the X/Y plane preferably extends parallel to the underfloor of the electric vehicle. Due to such an alignment alone, the charging connection is already protected and can be contacted in a particularly gentle manner since the contacts are not subject to stress in the lifting direction, i.e. the Z direction perpendicular to the X/Y plane. Moreover, the motor vehicle is not subjected to a force in the Z direction. The contacts can furthermore be synergistically shielded in the Z direction by housing or protective elements.

The charging connection is preferably mounted in a recess of the vehicle unit, whereby the risk of contamination or damage as a result of environmental and driving influences can be further reduced. Protection via the recess is provided in particular when the charging connection is located in the “slipstream” of the walls defining the recess, so that dirt, water and road stones do not strike the charging connection directly during the driving operation, but brush past it, as it were.

The vehicle unit preferably has a positioning element, which is designed to guide the contacting device during the external introduction to the vehicle unit, so that the contacting device arrives in the defined centering position. The positioning element can be formed for example as a centering pin, which cooperates with a corresponding, preferably conical recess of the contacting device. The aim of the positioning element is therefore that the contacting device arrives reliably in the centering position in the vehicle unit, even if positional deviations arise as a result of variable parking positions of the vehicle or inaccuracies during the introduction via the external device, for example. The position of the contacting device in the X/Y plane is therefore defined, although the alignment thereof, i.e. the angle about the Z axis, may be unspecified. In this case, the centering position of the contacting device is therefore achieved through the work of the above-mentioned external device, for instance by a robot arm, and the cooperation with the positioning element.

The vehicle unit preferably has a cover for covering the charging connection. In the closed state, the cover preferably terminates substantially coplanar with the underfloor of the electric vehicle or the corresponding wall on which the vehicle unit is located. The charging connection and any further components of the vehicle unit are thus particularly effectively protected against mechanical external influences, such as road stones, dirt and the like, in the normal state, i.e. outside the charging operation. The cover can be provided with a seal in order to protect the charging connection in particular against spray water and moisture.

The cover is preferably pivotably mounted, for instance by means of a four-bar linkage, in order to thereby be pivotable from an open position into a closed position, and vice versa. For actuation purposes, a corresponding actuator, preferably an electric motor or servo, with a transmission mechanism (pinion, rod system and the like), collectively referred to as a “drive”, can be provided.

The drive for the cover preferably has an over-center kinematic system, whereby the cover can be tightly and reliably closed without a separate locking means.

The vehicle unit preferably comprises a housing defining a recess, which housing can have in particular an elongated form, wherein the charging connection is preferably arranged in the recess, at one end thereof, such that the contacts of the charging connection extend parallel to the X/Y plane. In other words, the charging connection can be arranged in a recess in the vehicle unit, whereby a particularly protected form of the vehicle unit is provided. A modular construction of the vehicle unit is facilitated by a separate housing, so that this vehicle unit can be easily installed on different vehicle types and in different positions.

The contacting mechanism is preferably designed to rotate the contacting device, in the centering position, about an axis perpendicular to the X/Y plane into an aligned position in which the contacts of the contacting device are facing the contacts of the charging connection. It is therefore unnecessary for the contacting device to be correctly aligned by an external device; instead, according to this preferred embodiment, the alignment, in particular adjustment about the Z axis, takes place within and via technical means of the vehicle unit. This technical solution is particularly tolerance-insensitive, robust and reliable.

The contacting mechanism is further or alternatively preferably designed to transfer the contacting device in a translatory manner from the aligned position to the contact position. The contacting and/or mating procedure is therefore executed within and via technical means of the vehicle unit, whereby the electrical and mechanical connection between the contacting device and the charging connection can be realized in a particularly defined and reliable, and therefore gentle and durable, manner.

The contacting mechanism preferably has an actuator and a kinematic system for executing the movement along the trajectory in the X/Y plane into the contact position. The actuator preferably comprises an electric motor or a servo. The kinematic system can be formed as a 4-bar-linkage kinematic system, whereby the necessary movement takes place in a mechanically simple and reliable manner.

The kinematic system preferably has at least one aligning arm, preferably two aligning arms, for gripping the contacting device in the centering position. The aligning arms can each be equipped with a hook or other gripping means at the corresponding ends in order to mechanically grasp the contacting device and reliably manipulate the position and/or location thereof. In this case, the term “grip” can have a broad interpretation and does not have to comprise an active gripping movement. By way of example, hooking, latching, engaging, connecting, butting procedures, etc. are included.

The contacting mechanism is preferably designed to grip or grasp the contacting device via the aligning arms, preferably via possible hooks thereof, upon the actuation of the actuator and to rotate it, in the centering position, about an axis perpendicular to the X/Y plane into the aligned position, and then transfer it in a translatory manner from the aligned position to the contact position upon the further actuation of the actuator. A plurality of movement forms can thus be executed by means of one and the same actuator, whereby the construction of the vehicle unit is simplified and the reliability increased.

The contacting mechanism preferably has a carriage, which is designed to move the contacting device, together with the kinematic system, in a translatory manner in the contacting direction upon the further actuation of the actuator. This provides a structurally simple and reliable technical solution for implementing a rotational alignment of the contacting device and a subsequent translatory contacting movement.

The above-mentioned object is further solved by a charging system for charging a battery of an electric vehicle. The charging system has a vehicle unit according to an embodiment of the above description and an external charging device for charging the battery of the electric vehicle. The charging device has the contacting device for the contacting, in particular mechanical and electrical contacting, by the charging connection of the vehicle unit and an external movement mechanism or an external device for transferring the contacting device into the centering position. To this end, the external device can have a robot arm or other suitable mechanism, which enables a movement of the contacting device along one or more degrees of freedom, in particular along the Z axis.

The features, technical effects, advantages and exemplary embodiments which have been described with reference to the vehicle unit apply analogously to the charging system.

The charging device preferably has a floor unit arranged in the floor, which comprises the contacting device and the corresponding external movement mechanism. The charging device can thus interact with a vehicle unit installed in the underfloor of the electric vehicle in a space-saving manner.

Further advantages and features of the present invention are revealed in the following description of preferred exemplary embodiments. The features described therein can be implemented in isolation or in combination with one or more of the features presented above, provided the features do not conflict with one another technically. In this case, the following description of preferred exemplary embodiments makes reference to the accompanying drawings.

### BRIEF DESCRIPTION OF THE FIGURES

Preferred further embodiments of the invention are explained in more detail by the following description of the figures, in which:

FIG. 1 shows a schematic perspective view from below of an external contacting device and a vehicle unit with a closed cover;

FIG. 2 shows a schematic perspective view from below of the external contacting device and the vehicle unit according to the exemplary embodiment of FIG. 1 with an open cover;

FIG. 3 shows a schematic perspective view from below of the external contacting device and the vehicle unit according to the exemplary embodiment of FIG. 1 with an open cover, wherein the contacting device is located in the centering position;

FIG. 4 shows a schematic perspective view from below of the external contacting device and the vehicle unit according to the exemplary embodiment of FIG. 1 with an open cover, wherein the contacting device is located in the aligned position;

FIG. 5 shows a schematic perspective view from below of the external contacting device and the vehicle unit according to the exemplary embodiment of FIG. 1 with an open cover, wherein the contacting device is located in the contact position;

FIG. 6 shows a schematic perspective view from above of the external contacting device and the vehicle unit according to the exemplary embodiment of FIG. 1 with an open or transparent housing;

FIG. 7A shows a plan view of the vehicle unit according to the exemplary embodiment of FIG. 1 with an open or transparent housing in the centering position;

FIG. 7B shows a view of the vehicle unit from below according to the exemplary embodiment of FIG. 1 in the centering position;

FIG. 8A shows a plan view of the vehicle unit according to the exemplary embodiment of FIG. 1 with an open or transparent housing in the aligned position;

FIG. 8B shows a view of the vehicle unit from below according to the exemplary embodiment of FIG. 1 in the aligned position;

FIG. 9A shows a plan view of the vehicle unit according to the exemplary embodiment of FIG. 1 with an open or transparent housing in the contact position;

FIG. 9B shows a view of the vehicle unit from below according to the exemplary embodiment of FIG. 1 in the contact position.

### DETAILED DESCRIPTION OF PREFERRED EXEMPLARY EMBODIMENTS

Preferred exemplary embodiments are described below with the aid of the figures. In this case, identical, similar or similarly acting elements in the different figures are denoted by identical reference signs, and a repeated description of these elements is sometimes omitted in order to avoid redundancy.

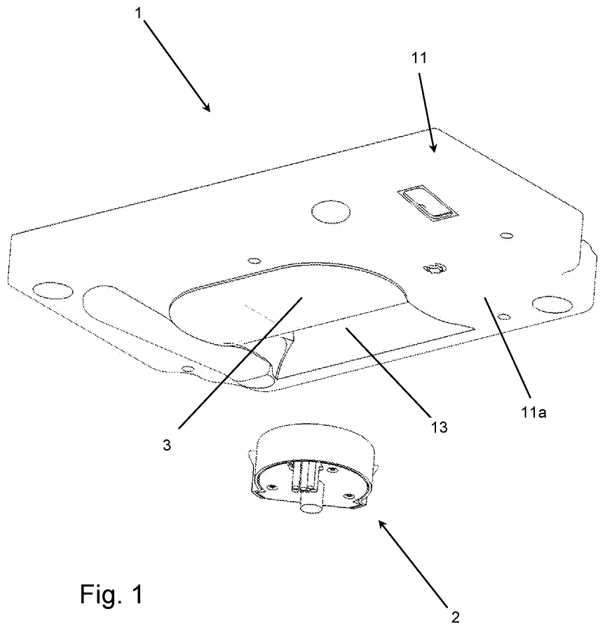

FIGS. 1 to 9B show a vehicle unit 1 of a charging system for charging a traction battery of an electric vehicle in various states and from different perspectives. The traction battery and the electric vehicle are not illustrated for the sake of clarity. The vehicle unit 1 is installed or installable on the vehicle, preferably on or in the underfloor of the vehicle, and is designed to receive an external contacting device 2 for the charging procedure of the traction battery and to align and/or to displace said contacting device at least partially independently, such that a reliable electrical and preferably likewise mechanical contact is achieved. The charging of the traction battery therefore takes place particularly preferably conductively herein.

It should be pointed out that the vehicle unit 1 can alternatively be installed at another point in the electric vehicle, for example on the side of a vehicle, for instance in the region of the tank fill pipe of a conventional vehicle with an internal combustion engine, or in the region of the vehicle roof.

In most of the figures, the external contacting device 2 is likewise shown, which is movable, for instance displaceable in a translatory manner and/or rotatable and/or pivotable, by an external mechanical unit (not illustrated), for example a robot arm, to guide the contacting device 2 towards the vehicle unit 1.

The necessary degrees of freedom for the first, rough adjustment of the contacting device 2 by the external device depend on the specific configuration of the system and requirements in terms of the necessary precision. For an installation in the floor, the contacting device 2 has to be realized such that it can be lifted and lowered at least relative to the vehicle floor, wherein a mobility in the plane perpendicular thereto is preferably likewise implemented.

The axis of the movement of the contacting device 2 towards the vehicle unit 1, i.e. the axis in the direction of gravity in the case of an installation in the floor, shall be defined herein as the Z axis. The plane perpendicular thereto shall be referred to as the XN plane.

The external contacting device 2 is supplied with a charging current from a charging device (not explained in more detail), which, after contacting with the vehicle unit 1 has been established, is conducted to the traction battery in the vehicle for the purpose of charging said battery.

The charging device providing the charging current can be provided in the form of a wall box or charging station, for instance, in which the charging control is also provided. Alternatively, the control of the charging procedure can also take place at the vehicle by means of corresponding electronics on board the electric vehicle, via an app or in another way.

The charging system, comprising at least the vehicle unit 1 and the external contacting device 2, serves to establish automatic contacting with the electric vehicle and then to start a charging procedure, preferably likewise automatically, in order to charge the traction battery in the electric vehicle. In this case, it should be achieved that the entire contacting procedure and preferably the charging procedure proceed substantially automatically, so that the driver or user of the electric vehicle does not need to intervene.

To this end, the driver must drive his vehicle into a defined contacting area within which the automatic contacting can be accomplished. For the installation in the floor, it is sufficient to park the vehicle above a floor unit of the charging device having the above-described external contacting device 2, which floor unit is mounted in or on the floor of the parking spot.

The contacting can now be started automatically or as a result of user interaction. In this regard, for example, automatic communication can take place between the electric vehicle to be charged and the charging device and, if the charge state of the electric vehicle is below a specified charge state, a contacting and charging procedure is started automatically. However, the automatic contacting and charging can, for example, also be implemented such that the driver actively initiates the charging procedure; however, further manual interaction between the driver and the charging device is then at least unnecessary.

The technical construction of the vehicle unit 1 and the external contacting device 2 and the contacting procedure are described in detail below with reference to FIGS. 1 to 5.

The vehicle unit 1 in the present exemplary embodiment has a housing 11, which is installed, for example screwed, in a corresponding receptacle in the electric vehicle, or can be received and installed therein. It should be pointed out that the vehicle unit 1 can be realized as a modular structural unit integrated with the electric vehicle to the extent that it is possible to dispense with a separate housing 11, for example.

The vehicle unit 1 can be integrated in a substantially planar manner in the underfloor of the electric vehicle. To realize the planar integration, the housing 11 of the vehicle unit 1 is inserted into the electric vehicle to the extent that the downwardly facing floor 11a of the housing 11 terminates substantially level with the floor of the electric vehicle.

However, it is likewise possible to fasten the vehicle unit 1 to the side or to/on the roof of the electric vehicle; however, the exemplary embodiments are hereinafter restricted to the installation of the vehicle unit 1 on or in the underfloor of the electric vehicle.

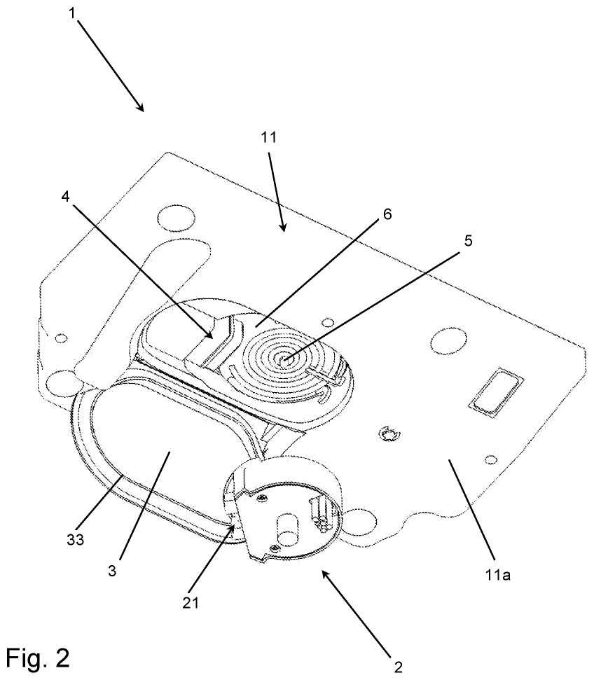

The vehicle unit 1 in FIG. 1 is illustrated in a perspective view from below, wherein a cover 3 for covering a recess 6 (shown in FIG. 2) can be seen in a closed position. The recess 6 contains, amongst other things, a charging connection 4, which is to be brought into mechanical and electrical contact with the external contacting device 2 for the charging procedure.

The cover 3 is designed to protect the recess 6 and the components located therein against mechanical external influences, such as road stones, dirt, moisture and the like, in the normal state, i.e. outside the charging operation. A seal 33 can additionally be provided for this purpose, as can be seen in FIGS. 2 to 5, 7B, 8B and 9B.

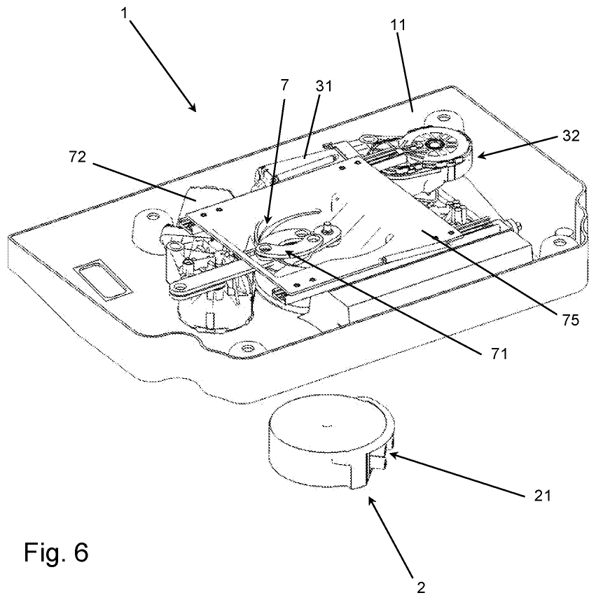

To this end, the cover 3 is preferably pivotably mounted, for instance by means of a four-bar linkage, in order to thereby be pivotable from an open position into a closed position, and vice versa. A corresponding actuator 31, preferably an electric motor or servo, with a transmission mechanism 32 (pinion, rod assembly, four-bar linkage and the like) is revealed in FIGS. 6, 7A, 8A and 9A.

The cover 3 can furthermore be easily and reliably held in the closed position by means of an over-center kinematic system of the actuator 31 and the transmission mechanism 32, without requiring additional means for locking the cover 3.

An embodiment of the cover 3 with an actuator or drive, which moves the cover in a translatory manner or along another trajectory from the closed position into an open position, and vice versa, is likewise possible.

However, with the harsh conditions beneath a vehicle, mounting the cover 3 via a four-bar linkage is preferred over a purely translatory mounting since the cover 3 is then less sensitive to contamination and easier to clean, for example within the course of regular maintenance by a specialist workshop.

The cover 3 preferably closes the vehicle unit 1 in a planar or substantially planar manner. The housing 11 of the vehicle unit 1 preferably has a depression 13 (c.f. FIG. 1), into which the cover 3 can move entirely or partially when opened.

The vehicle unit 1 according to the exemplary embodiment of FIG. 1 is illustrated with the cover 3 in the open position in FIG. 2. The cover 3 has been partially moved into the specifically provided depression 13 in the housing 11 of the vehicle unit 1.

As a result of the movement of the cover 3 to the side, the recess 6, in which the charging connection 4 and furthermore a positioning element 5 are arranged, is now exposed. The positioning element 5 in the exemplary embodiments shown is designed in the form of a centering to pin. However, the positioning element 5 can also be provided in other mechanical configurations —preferably such as those which enable form-fitting engagement between the contacting device 2 and the positioning element 5. It can therefore be sufficient to match the walls of the recess 6 and the contacting device 2 to one another, preferably to implement a conical self-centering form.

The contacting device 2 has a mating piece (not shown in more detail in the figures) for the positioning element 5, for example a conical recess, which cooperates with the positioning element 5 during the insertion of the contacting device 2 into the recess 6 such that the contacting device 2 is adjusted in the X/Y plane.

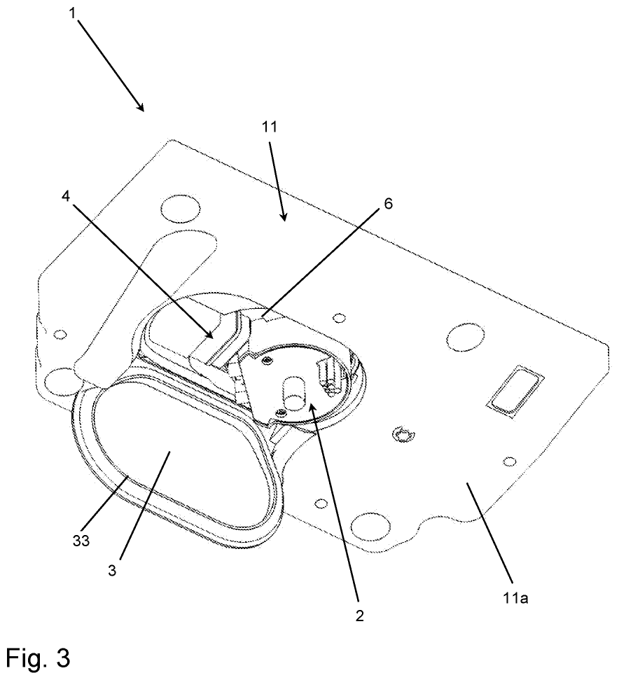

The aim of the positioning element 5 is that the contacting device 2, after its insertion into the recess 6, arrives in a defined position, as shown in FIG. 3, The spatial position of the contacting device 2 is therefore well-defined; however, the alignment thereof, i.e. the angle about the Z-axis, may be unspecified. This state shown in FIG. 3 shall be referred to herein as “centering position” so as to make clear that the contacting device 2, after its insertion via an external device, is in a defined, centered position in the recess 6.

The centering position of the contacting device 2 is achieved through the work of the above-mentioned external mechanical device (for example robot arm) and cooperation with the positioning element. The further positioning of the contacting device 2 within the recess 6 and ultimately contacting by the charging connection 4 now take place solely via internal devices of the vehicle unit 1, whereby these movements can be executed in a particularly precise, gentle and energy-saving manner.

The charging connection 4 and the contacts thereof are formed according to the present exemplary embodiment such that the contacting, starting from the centering position, and the disconnection of the contacting device 2 and the charging connection 4 can be executed in a direction or along a trajectory which are located in the X/Y plane, i.e. preferably in a plane located parallel to the underfloor of the vehicle. In other words, the charging connection 4 and the contacts thereof (not shown in the figures) are present in an alignment parallel to the X/Y plane so that contacting can be achieved via a translatory movement in the X/Y plane.

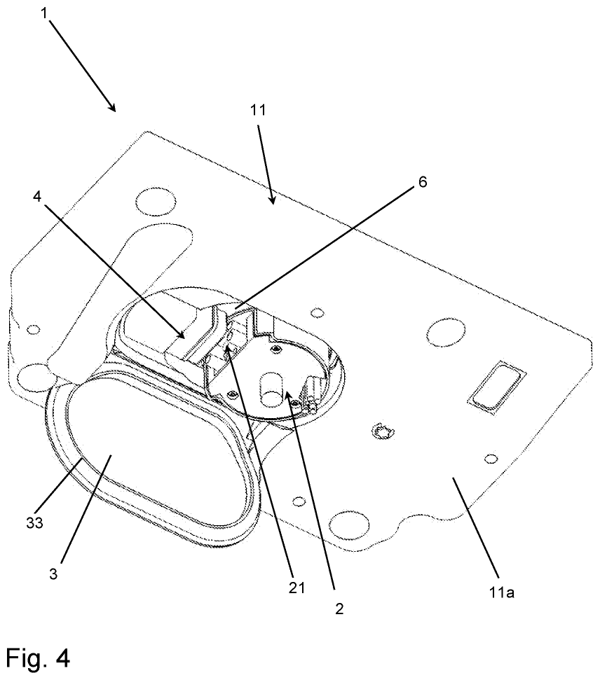

However, the angular alignment of the contacting device 2 must be corrected beforehand, as revealed in FIG. 4. This state shall be referred to herein as “aligned position” so as to make clear that the contacting device 2 is aligned within the recess 6 such that its contacts 21 are facing the charging connection 4 and the contacts thereof.

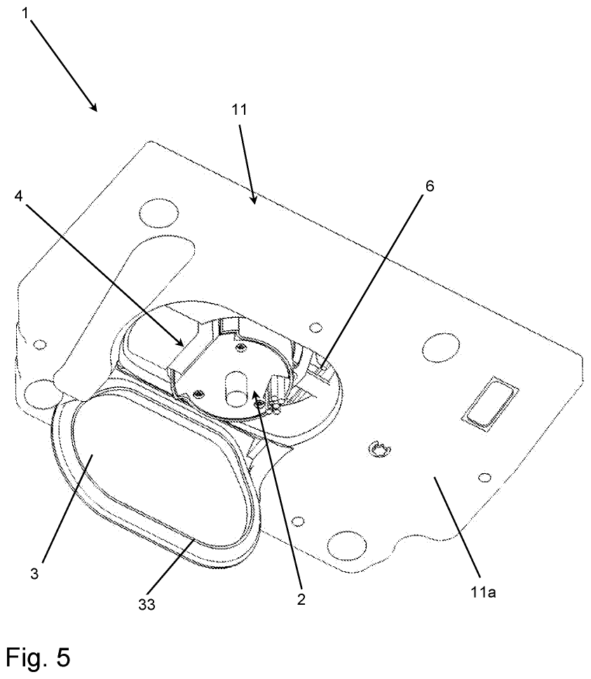

After the correction of the angular position of the contacting device 2 to the aligned position, a translatory movement towards the charging connection 4 is sufficient to establish a form-fitting and electrical connection between the two. This state, referred to herein as “contact position”, is shown in FIG. 5.

In the present exemplary embodiment, the contacting device 2 and the charging connection 4 form a plug/socket connection which, in addition to the purely electrical contact, also establish a form fit in order to ensure reliable contacting during the charging procedure. In this case, the contacting device 2 preferably functions as a plug, whilst the charging connection 4 functions as a socket. However, the form fit can also be realized the other way around. A form fit between the contacting device 2 and charging connection 4 is furthermore not absolutely necessary if a secure electrical contact is ensured in another way in the contact position.

The charging connection 4 and the positioning element 5 are mounted in the recess 6 in a protected manner so that the risk of contamination or damage as a result of environmental and driving influences is reduced. The alignment of the contacts likewise protects both the charging connection 4 and the contacting device 2 in the X/Y plane against damage and contamination, since these can be easily shielded in the Z direction by housing or protective elements. Protection is already provided by the recess 6 alone, in particular when the charging connection 4 is located in “slipstreams” of the walls defining the recess 6, so that dirt, water and road stones do not strike the charging connection 4 directly during the driving operation, but brush past it, as it were.

If the recess 6 is then completely closed by the cover 3 and the charging connection 4 is therefore particularly effectively protected, contamination during the driving operation can be prevented entirely and the durability and functioning of the charging connection 4 can therefore be maintained over a long time.

The internal transfer of the contacting device 2 from the centering position (FIG. 3) to the aligned position (FIG. 4), and ultimately to the contact position (FIG. 5), which is carried out within and by the vehicle unit 1, has been explained above. A specific mechanism according to a preferred embodiment for realizing this movement trajectory is explained below with reference to FIGS. 6 to 9B.

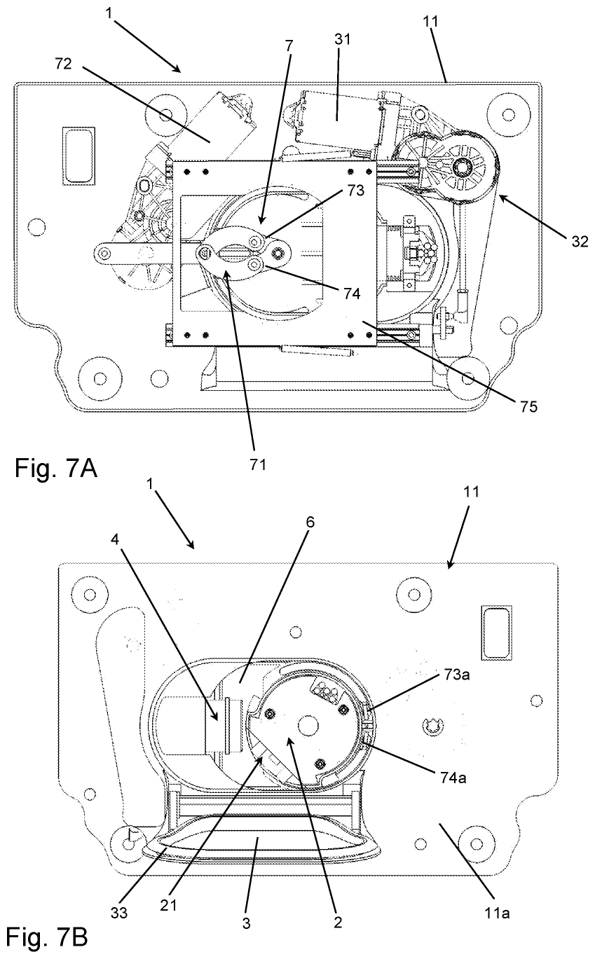

FIG. 6 is a schematic perspective view of the contacting device 2 and the vehicle unit 1 at an angle from above, wherein the housing 11 is shown open or transparent in order to illustrate the mechanism for the internal transfer of the contact device 2 into the contact position. This mechanism is referred to herein as “contacting mechanism” and is denoted by the reference sign 7. A plan view of the contacting mechanism in different states is shown in FIGS. 7A (centering position), 8A (aligned position) and 9A (contact position).

The contacting device 2 is not visible in FIGS. 7A, 8A and 9A, since it is located on the underside of the vehicle unit 1 and is substantially concealed; however, the contacting device 2 is revealed in FIGS. 7B, 8B and 9B, which show the vehicle unit 1 from below, likewise in the different states.

The contacting mechanism 7 according to the present embodiment comprises a 4-bar linkage kinematic system 71 and an actuator 72, which is preferably en electric motor or servo. The drive force of the actuator 72 is transmitted to the 4-bar linkage kinematic system 71 via a transmission mechanism, comprising a pinion and/or rod assembly or the like, for example.

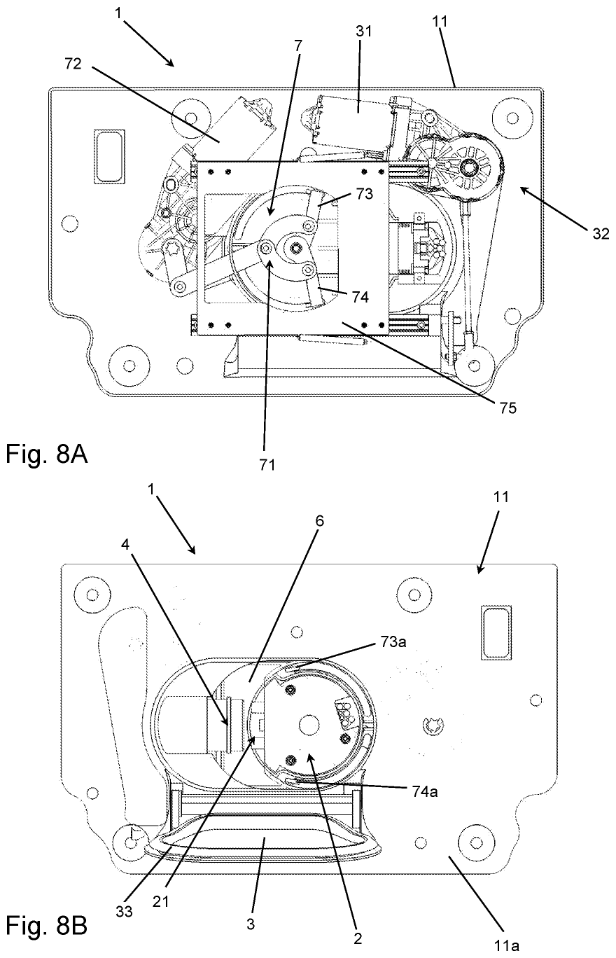

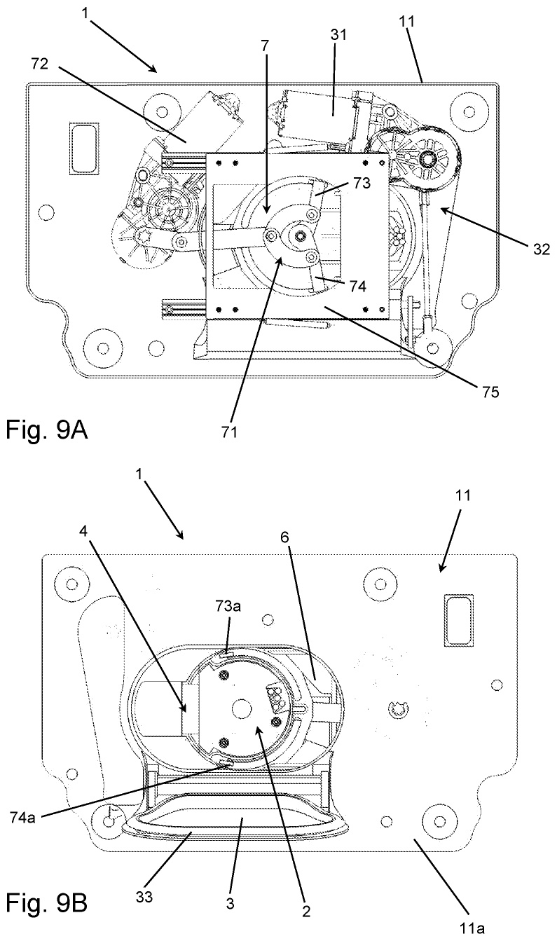

The 4-bar linkage kinematic system 71 has two aligning arms 73 and 74 with hooks 73a and 74a at their ends. The aligning arms 73 and 74 are revealed most clearly in FIGS. 8A and 9A, which show the contacting mechanism 7 in the aligned position (FIG. 8A) and the contact position (FIG. 9A).

In the same system, FIGS. 8B and 9B show the vehicle unit 1 from below in the aligned-position and contact-position states.

The aligning arms 73 and 74 with hooks 73a and 74a serves for gripping, aligning and contacting purposes and possibly for locking the contacting device 2.

The actuator 72 starts the contacting procedure, wherein the 4-bar linkage kinematic system 71 is firstly triggered, which grips and aligns the centered contacting device 2 via the hooks 73a and 74a, as revealed by comparing FIGS. 7B and 8B. The alignment is an adjustment or rotation of the contacting device 2 about the Z axis in the X/Y plane.

The alignment of the contacting device 2 follows the engagement of both hooks 73a and 74a in corresponding recesses, undercuts or the like of the contacting device 2 and the subsequent actuation of the 4-bar linkage kinematic system 71.

A carriage 75, together with the 4-bar linkage kinematic system 71, is then moved as a result of the further movement of the actuator 72 in the contacting direction or mating direction, i.e. in a translatory manner in the X/Y plane. The subsequent release of the carriage 75 takes place either via a link motion or by means of a spring, wherein the spring force must be greater than the force required for the 4-bar linkage kinematic system 71.

According to the charging system explained above, which comprises at least the vehicle unit 1 and contacting device 2, particularly convenient charging of a traction battery of an electric vehicle can be realized, in which the driver or user, after parking the motor vehicle, for instance above a floor unit of the external charging device and possibly as a result of initiating the charging procedure, does not have to undertake any further steps since the system carries this out automatically and independently.

In particular, for the contacting of the traction battery by a charging device, the user does not need to guide a charging cable with a plug from a wall box or a charging station to the motor vehicle and insert the plug manually into a charging socket on the vehicle; instead, this procedure takes place automatically.

Similarly, it can thus be effectively avoided that a user who is ready to drive off needs to climb out of the vehicle again to release the connection if the contacting of the motor vehicle is still established. Instead, by means of the proposed technical solution, automatic, independent disconnection can also be achieved, which is executed for example when the actual charging procedure has ended, i.e. the battery is sufficiently or completely recharged, or is initiated for example by opening the motor vehicle door, stepping inside the motor vehicle or starting the motor vehicle. In other words, a user does not have to undertake any active steps to disconnect the established contacting by the charging device. However, it can also be provided that the user specifies active disconnection via a corresponding disconnect command.

According to the exemplary embodiments explained above, the alignment of the contacting device 2, in particular an adjustment about the Z axis, and the contacting and mating procedure take place within and via technical means of the vehicle unit 1. This solution is less sensitive to tolerances, more robust and more reliable than an alignment via an external device, such as a robot arm. Moreover, the forces on the external device are moreover lowered, thereby facilitating a lightweight construction of the charging system.

According to a preferred exemplary embodiment, the contacting device 2 is locked by the hooks 73a and 74a, preferably in the Z direction, whereby release from the outside is prevented. The charging procedure can thus be executed particularly reliably and securely.

The cover 3 is preferably formed as a pivoted flap. A structurally simple, reliable and robust system is thus implemented. Sealing, for instance against moisture, can furthermore be easily realized in this way. Locking of the cover 3 can additionally be realized synergistically by the actuator 72 and possibly using the 4-bar linkage kinematic system 71.

If applicable, all individual features which are represented in the exemplary embodiments can be combined and/or interchanged with one another without departing from the scope of the invention.

### LIST OF REFERENCE SIGNS

1 Vehicle unit
11 Housing
11a Floor of the housing
13 Depression
2 Contacting device
21 Contacts
3 Cover
31 Actuator
32 Transmission mechanism
33 Seal
4 Charging connection
5 Positioning element
6 Recess
7 Contacting mechanism
71 4-bar linkage kinematic system
72 Actuator
73 Aligning arm
73a Hooks
74 Aligning arm
74a Hooks

1. A vehicle unit configured to be installed in an electric vehicle and for electrical contacting of an external charging device for charging a battery of the electric vehicle, wherein the vehicle unit comprises:
a charging connection configured to contact a contacting device of the external charging device in a contact position; and
a contacting mechanism configured to transfer the contacting device along a trajectory in an X/Y plane from a centering position, in which the contacting device is not connected to the charging connection, to the contact position.

2. The vehicle unit (1) as claimed in claim 1, wherein contacts of the charging connection, which are configured to be brought into electrical contact with contacts of the contacting device, are aligned parallel to the X/Y plane.

3. The vehicle unit as claimed in claim 2, further comprising a positioning element, formed as a centering pin, which is configured to guide the contacting device during the introduction to the vehicle unit by an external device such that the contacting device arrives in a well-defined centering position.

4. The vehicle unit as claimed in claim 3, further comprising a cover for covering the charging connection, wherein the cover terminates substantially coplanar with the under floor of the electric vehicle in the closed state.

5. The vehicle unit as claimed in claim 4, wherein the cover is movable, pivotable, between a closed position and an open position by a drive.

6. The vehicle unit as claimed in claim 5, wherein the drive for the cover has an over-center kinematic system, whereby the cover is configured to be tightly closed in the closed state.

7. The vehicle unit as claimed in claim 6, wherein the vehicle unit comprises a housing defining an elongated recess, and the charging connection is arranged in the recess, at one end thereof, such that the contacts of the charging connection extend parallel to the X/Y plane.

8. The vehicle unit as claimed in claim 7, wherein the contacting mechanism is configured to rotate the contacting device, starting from the centering position, about an axis perpendicular to the X/Y plane into an aligned position in which the contacts of the contacting device are facing the contacts of the charging connection.

9. The vehicle unit as claimed in claim 8, wherein the contacting mechanism is configured to transfer the contacting device in a translatory manner from the aligned position to the contact position.

10. The vehicle unit as claimed in claim 9, wherein the contacting mechanism comprises an actuator, comprising at least one of: an electric motor and a servo, and a kinematic system, formed as a 4-bar linkage kinematic system.

11. The vehicle unit as claimed in claim 10, wherein the kinematic system comprises at least one aligning arm, for gripping the contacting device in the centering position.

12. The vehicle unit as claimed in claim 11, wherein the contacting mechanism is configured to grip the contacting device via the at least one aligning arms, via hooks thereof, upon an actuation of the actuator and to rotate said contacting device about an axis perpendicular to the X/Y plane from the centering position to the aligned position, and to then transfer it in a translatory manner from the aligned position to the contact position upon the further actuation of the actuator.

13. The vehicle unit as claimed in claim 12, wherein the contacting mechanism comprises a carriage, which is configured to move the contacting device, together with the kinematic system, in a translatory manner in the contacting direction upon the further actuation of the actuator.

14. A charging system having a vehicle unit and an external charging device for charging a battery of an electric vehicle, wherein the charging device comprises a contacting device for configured to contact by a charging connection of the vehicle unit and an external mechanism for transferring the contacting device into a centering position.

15. The charging system as claimed in claim 14, wherein the charging device comprises a floor unit arranged in the floor, which floor unit comprises the contacting device, and the vehicle unit is configured to be at least one of: installed and installable in the under floor of the electric vehicle.

16. The vehicle unit as claimed in claim 1, wherein the vehicle unit is configured to be installed in an electric vehicle in an under floor of the electric vehicle.

17. The vehicle unit as claimed in claim 16, wherein the X/Y plane extends parallel to the under floor of the electric vehicle.

18. The vehicle unit as claimed in claim 3, wherein the external device is a robot arm.

19. The vehicle unit as claimed in claim 11, wherein the kinematic system comprises two aligning arms.

20. The charging system of claim 14, wherein the vehicle unit comprises:
the charging connection configured to contact the contacting device of the external charging device in a contact position; and
a contacting mechanism configured to transfer the contacting device along a trajectory in an X/Y plane from the centering position, in which the contacting device is not connected to the charging connection, to the contact position;
wherein the external mechanism is a robot arm.
